(19) United States
(12) Patent Application Publication
(10) Pub. No.: US 2024/0051490 A1
(43) Pub. Date: Feb. 15, 2024

(54) ENERGY ABSORBING MATERIAL FOR IMPROVED VULNERABLE ROAD USER PERFORMANCE FOR A VEHICLE

(71) Applicant: GM GLOBAL TECHNOLOGY OPERATIONS LLC, Detroit, MI (US)

(72) Inventors: Rajamanickam VS, Bangalore (IN); Vivekananda Kinila, Karnataka (IN); Biswajit Tripathy, Bangalore (IN); Varun Agarwal, Bangalore (IN)

(21) Appl. No.: 17/883,791

(22) Filed: Aug. 9, 2022

(51) Int. Cl. B60R 21/34; B62D 25/10; B62D 27/02; B32B 5/18; B32B 3/26; B32B 7/12

(52) U.S. Cl. CPC B60R 21/34; B62D 25/105; B62D 27/026; B32B 5/18; B32B 3/263; B32B 7/12; B32B 2307/558; B32B 2605/08

(57) ABSTRACT

A hood assembly of a vehicle includes a hood outer panel defining an outer surface of the hood assembly, and a hood inner panel defining an inner surface of the hood assembly, such that a hood cavity is defined between the hood inner panel and the hood outer panel. An energy absorbing material is located at the hood inner panel. The energy absorbing material includes a multi-cellular structure formed from a plurality of interconnected cells having a lattice structure. Each of the plurality of interconnected cells includes at least four nodes and at least one lattice element extending between each of the at least four nodes. The at least one lattice element has a diameter no greater than 2.5 mm.

### INTRODUCTION

The subject disclosure relates to the art of vehicles and, more particularly, to an energy absorption material for a vehicle.

There are numerous safety standards that apply to the manufacture of vehicles. Many of the standards are directed to acceleration force limits that a vulnerable road user (VRU), such as a pedestrian or a cyclist, may experience during an impact event with the vehicle. One area where vehicles are evaluated for such standards is at the hood area of the vehicle, where the hood assembly must absorb a certain amount of energy so as to reduces head impact forces and meet head injury criteria (HIC) standards for a VRU. The current solutions include the usage of flexible metal brackets at particular areas of impact, such as the underhood shock tower area, and the headlamp area. Such metal brackets, however, have limited adjustability to meet the required performance standards.

### SUMMARY

In one embodiment, a hood assembly of a vehicle includes a hood outer panel defining an outer surface of the hood assembly, and a hood inner panel defining an inner surface of the hood assembly, such that a hood cavity is defined between the hood inner panel and the hood outer panel. An energy absorbing material is located at the hood inner panel. The energy absorbing material includes a multi-cellular structure formed from a plurality of interconnected cells having a lattice structure. Each of the plurality of interconnected cells includes at least four nodes and at least one lattice element extending between each of the at least four nodes. The at least one lattice element has a diameter no greater than 2.5 mm.

Additionally or alternatively, in this or other embodiments the energy absorbing material is located in the hood cavity.

Additionally or alternatively, in this or other embodiments the energy absorbing material has one of a trapezoidal or circular cross-sectional shape.

Additionally or alternatively, in this or other embodiments the plurality of interconnected cells vary in size in the lattice structure.

Additionally or alternatively, in this or other embodiments the plurality of interconnected cells vary in packing density in the lattice structure.

Additionally or alternatively, in this or other embodiments the energy absorbing material is secured to one of the hood inner panel or the hood outer panel.

Additionally or alternatively, in this or other embodiments the energy absorbing material is secured to one of the hood inner panel or the hood outer panel via adhesive.

Additionally or alternatively, in this or other embodiments the energy absorbing material includes a support plate on which the multi-cellular structure is formed.

Additionally or alternatively, in this or other embodiments each of the plurality of interconnected cells is formed from one of a 3D printable nylon, Zytel, or ultramid.

In another embodiment, a vehicle includes a body including a hood assembly, and an energy absorbing material located at the hood assembly. The energy absorbing material includes a multi-cellular structure formed from a plurality of interconnected cells having a lattice structure. Each of the plurality of interconnected cells include at least four nodes and at least one lattice element extending between each of the at least four nodes. The at least one lattice element has a diameter no greater than 2.5 mm.

Additionally or alternatively, in this or other embodiments the hood assembly includes a hood outer panel defining an outer surface of the hood assembly, and a hood inner panel defining an inner surface of the hood assembly. A hood cavity is defined between the hood inner panel and the hood outer panel. The energy absorbing material is positioned at the hood inner panel.

Additionally or alternatively, in this or other embodiments the energy absorbing material is located in the hood cavity.

Additionally or alternatively, in this or other embodiments the energy absorbing material has one of a trapezoidal or circular cross-sectional shape.

Additionally or alternatively, in this or other embodiments the plurality of interconnected cells vary in size in the lattice structure.

Additionally or alternatively, in this or other embodiments the energy absorbing material is disposed over one of a headlamp or a suspension tower of the vehicle.

Additionally or alternatively, in this or other embodiments the plurality of interconnected cells vary in packing density in the lattice structure.

Additionally or alternatively, in this or other embodiments the energy absorbing material is secured to one of the hood inner panel or the hood outer panel.

Additionally or alternatively, in this or other embodiments the energy absorbing material is secured to one of the hood inner panel or the hood outer panel via adhesive.

In yet another embodiment, an energy absorbing material includes a multi-cellular structure formed from a plurality of interconnected cells having a lattice structure. Each of the plurality of interconnected cells include at least four nodes and at least one lattice element extending between each of the at least four nodes. The at least one lattice element has a diameter no greater than 2.5 mm. The plurality of interconnected cells vary in one or more of size or packing density in the lattice structure.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an illustration of an embodiment of a vehicle;

FIG. 2 is a cross-sectional view of a hood assembly of a vehicle at a headlamp area of the vehicle including an energy absorbing material in a trapezoidal configuration;

FIG. 3 is a cross-sectional view of a hood assembly of a vehicle at a headlamp area of the vehicle including an energy absorbing material in another trapezoidal configuration;

FIG. 4 is an illustration of an energy absorbing material in yet another trapezoidal configuration;

FIG. 5 is an illustration of an energy absorbing material in a circular configuration;

FIG. 6 is a schematic illustration of assembly of an energy absorbing material to a vehicle structure;

FIG. 7 is a cross-sectional view of the energy absorbing material including a multi-cellular lattice formed from a plurality of interconnected cells having a lattice structure, in accordance with a non-limiting example;

FIG. 8 is a plan view of the lattice structure of one of the plurality of interconnected cells of FIG. 7;

FIG. 9 is a cross-sectional view of the energy absorbing material including a multi-cellular lattice formed from a plurality of interconnected cells having a lattice structure, in accordance with another non-limiting example;

FIG. 10 is a plan view of the lattice structure of one of the plurality of interconnected cells of FIG. 9;

FIG. 11 is a cross-sectional view of the energy absorbing material including a multi-cellular lattice formed from a plurality of interconnected cells having a lattice structure, in accordance with a non-limiting example;

FIG. 12 is a plan view of the lattice structure of one of the plurality of interconnected cells of FIG. 11;

FIG. 13 is a cross-sectional view of the energy absorbing material including a multi-cellular lattice formed from a plurality of interconnected cells having a lattice structure, in accordance with yet another non-limiting example;

FIG. 14 is a plan view of the lattice structure of one of the plurality of interconnected cells of FIG. 13; and

FIG. 15 depicts a graph illustrating material properties of a material used to form the energy absorbing material, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

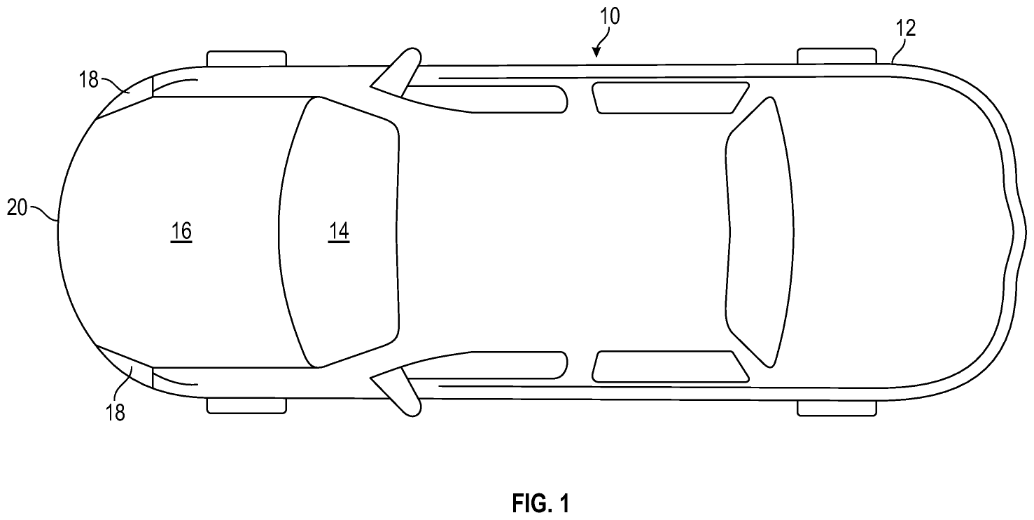

A vehicle, in accordance with a non-limiting example, is indicated generally at 10 in FIG. 1. Vehicle 10 includes a body 12 that defines an occupant compartment 14. The vehicle 10 further includes a hood assembly 16 and headlamps 18 generally located at a front end 20 of the vehicle 10.

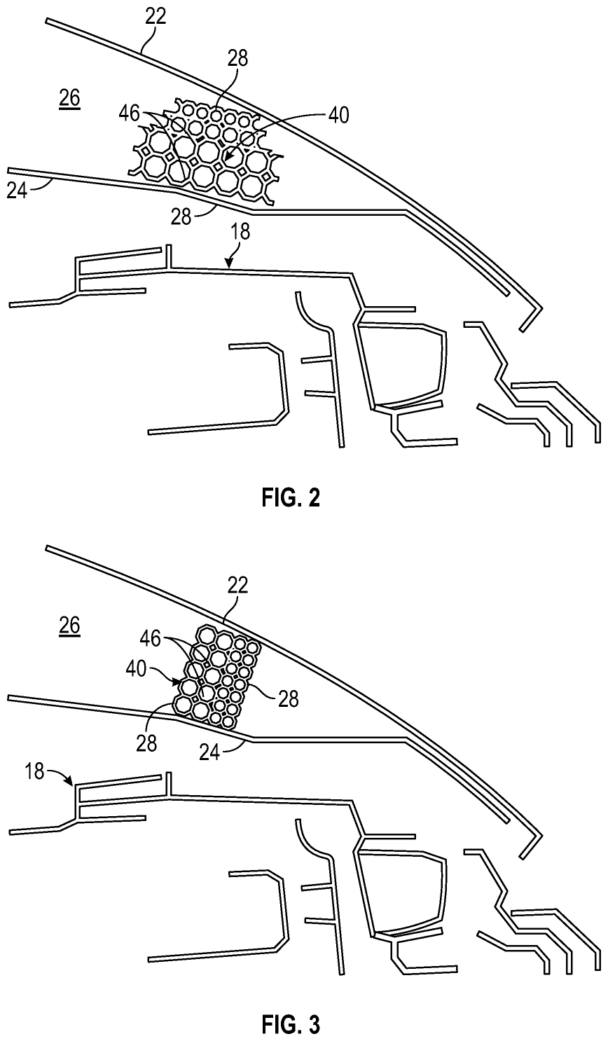

Referring now to the cross-sectional view of FIG. 2, the hood assembly 16 includes a hood outer panel 22 defining an outer surface of the hood assembly 16 and a hood inner panel 24 defining a hood cavity 26 between the hood outer panel 22 and the hood inner panel 24. An energy absorbing material 40 is positioned in the hood cavity 26 to absorb energy from an impact on the hood outer panel 22 from, for example, a vulnerable road user (VRU) such as a pedestrian or a cyclist. Absorbing the energy via the energy absorbing material 40 reduces potential injuries to the VRU. The energy absorbing material 40 is selectively located in the hood cavity 26 over certain areas of the underlying structure, especially where the hood inner panel 24 is located relatively closely to the underlying structure, such as over the headlamp 18, or over a suspension tower (not shown). This improves energy absorption and dissipation before the hood inner panel 24 comes in contact with, for example, the headlamp 18.

The energy absorbing material 40 is a 3-dimensional lattice structure including a plurality of interconnected cells 46. The plurality of interconnected cells 46 may be configured in a selected arrangement to provide a desired energy absorption based on, for example, anticipated or predicted impact angle, impact force, and available space in the hood cavity 26. For example, in the configuration of FIG. 2, the interconnected cells 46 are arranged in a trapezoidal configuration with a first parallel side 28 of the energy absorbing material 40 located at the hood inner panel 24 and a second parallel side 28 of the energy absorbing material 40 located at or near the hood outer panel 22. In another embodiment, illustrated in FIG. 3, the trapezoidal configuration is rotated relative to that of the embodiment of FIG. 2 such that the parallel sides 28 of the energy absorber are not aligned with the hood inner panel 24 or the hood outer panel 22. While in the illustrated embodiments, the energy absorbing material 40 is located between the hood inner panel 24 and the hood outer panel 22, in other embodiments, the energy absorbing material 40 is placed at a critical area, such as the headlamp 18 or shock tower, between the critical area and the hood assembly 16.

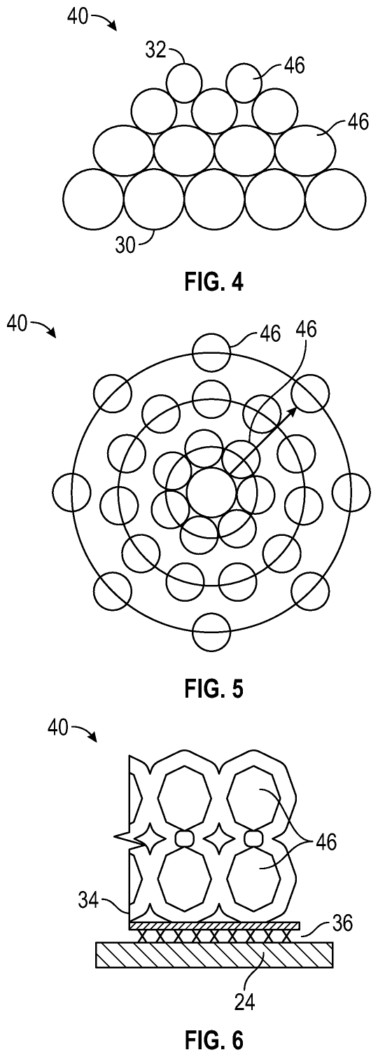

Referring now to FIGS. 4 and 5, the configuration of the plurality of interconnected cells 46 may vary across a cross-section of the energy absorber 40. For example, in the trapezoidal configuration of FIG. 4, a cell size of the interconnected cells 46 may be varied from a first side 30 to a second side 32 of the energy absorber 40, and/or a packing density of the interconnected cells 46 may be varied from the first side 30 to the second side 32. Another configuration is illustrated in FIG. 5, where the interconnected cells 46 are arranged in a circular configuration. In the circular configuration, the cell size of the interconnected cells 46 and/or the packing density of the interconnected cells 46 may be varied with, for example, distance from a center of the circular configuration to achieve the desired energy absorption performance.

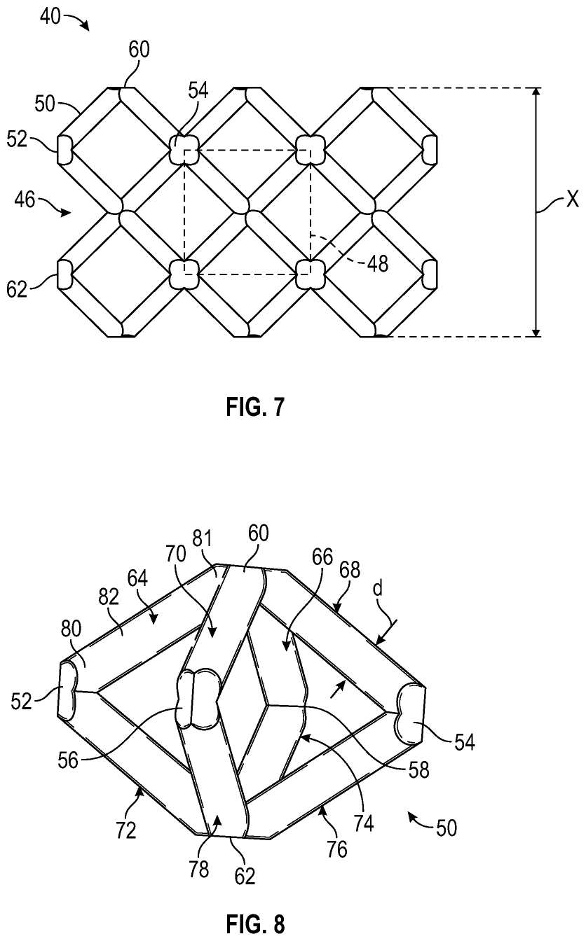

Referring now to FIG. 6, in some embodiments the energy absorbing material 40 is secured to the hood inner panel 24. One skilled in the art will readily appreciate, however, that this arrangement is merely exemplary and that the energy absorbing material 40 may be assembled to other components such as the hood outer panel 22, the headlamp 18 or the shock tower (not shown) to absorb energy from an impact to the hood assembly 16. The plurality of interconnected cells 46 are formed on a support plate 34 by, for example, one or more additive manufacturing processes, such as 3D printing processes. The energy absorbing material 40 is then secured to the hood inner panel 24 via a layer of adhesive 36 between the support plate 34 and the hood inner panel 24. One skilled in the art will appreciate that the layer of adhesive 36 is merely an exemplary securing means, and that other elements such as clips or screws may be utilized to secure the energy absorbing material 40 to the hood inner panel 24.

Referring to FIG. 7, energy absorbing material 40 takes the form of a multi-cellular structure including a plurality of interconnected cells 46. A plurality of interconnected cells 46 are connected so as to form a body centric cubic (BCC) structure 48. In a non-limiting example, energy absorbing material 40 has an overall thickness of about 30 mm. In another non-limiting example, energy absorbing material 40 includes an overall thickness “X” of about 25 mm. In yet another non-limiting example, each cell of the plurality of interconnected cells 46 includes a thickness no greater than 20 mm.

Reference will now follow to FIG. 8, with continued reference to FIG. 7, in describing a cell 50 of the plurality of interconnected cells 46. Cell 50 includes a first node 52, a second node 54, a third node 56, a fourth node 58, a fifth node 60, and a sixth node 62. Each of the nodes 52, 54, 56, 58, 60, and 62 are connected by lattice elements. In a non-limiting example, a first lattice element 64 joins first node 52 and fifth node 60. A second lattice element 66 joins fourth node 58 and fifth node 60, a third lattice element 68 joins second node 54 and fifth node 60, and a fourth lattice element 70 joins third node 56 and fifth node 60. A fifth lattice element 72 joins first node 52 and sixth node 62. A sixth lattice element 74 joins fourth node 58 and sixth node 62, a seventh lattice element 76 joins second node 54 and sixth node 62, and an eighth lattice element 78 joins third node 56 and sixth node 62.

In a non-limiting example, each lattice element includes a first end 80, a second end 81, and an intermediate portion 82 such as shown in connection with first lattice element 64. In a non-limiting example, each lattice element 64, 66, 68, 70, 72, 74, 76, and 78 includes a substantially constant diameter and extends substantially linearly between nodes. In a non-limiting example, each lattice element 64, 66, 68, 70, 72, 74, 76, and 78 has a diameter that is about 2 mm. In another non-limiting example, each lattice element 64, 66, 68, 70, 72, 74, 76, and 78 has a 1 mm diameter. It should be understood that the particular diameter of lattice elements 64, 66, 68, 70, 72, 74, 76, and 78 may vary and can be tuned to specific space requirements between the hood outer panel 22 and the hood inner panel 24.

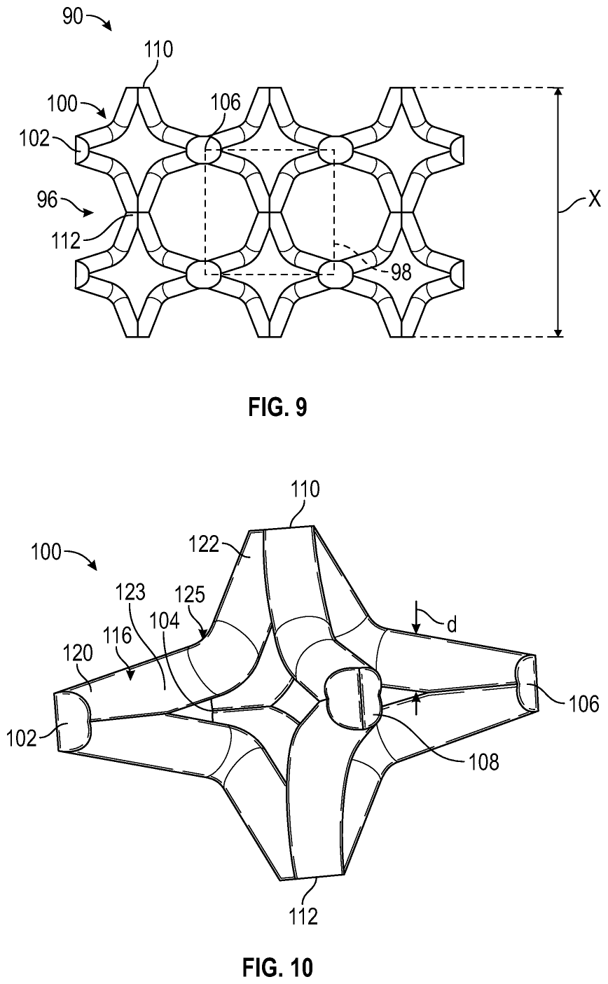

Reference will now follow to FIG. 9 in describing an energy absorbing material 90 formed in accordance with another non-limiting example. Energy absorbing material 90 comprises a multi-cellular structure formed from a plurality of interconnected cells 96. In a non-limiting example, a plurality of interconnected cells 96 are connected so as to form a body centric cubic (BCC) structure 98. In a non-limiting example, energy absorbing material 90 has an overall thickness “X” of about 30 mm. In another non-limiting example, energy absorbing material 90 includes an overall thickness of about 25 mm. In yet another non-limiting example, each cell of the plurality of interconnected cells 96 includes a thickness no greater than 20 mm.

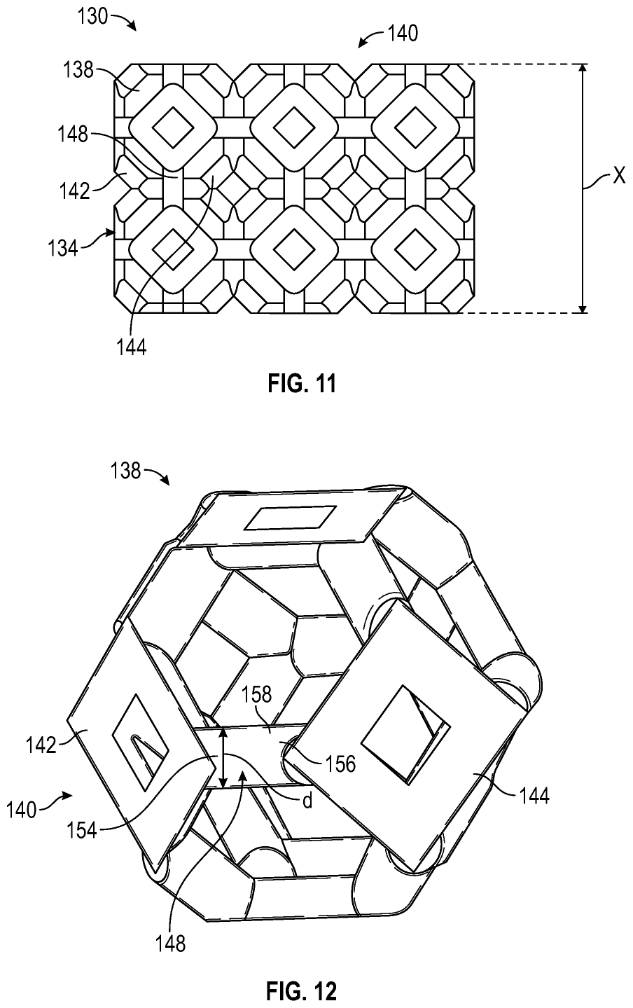

Reference will now follow to FIG. 10, with continued reference to FIG. 9 in describing a cell 100 of the plurality of interconnected cells 96. Cell 100 includes a first node 102, a second node 104, a third node 106, a fourth node 108, a fifth node 110, and a sixth node 112. Each of the nodes 102, 104, 106, 108, 110, and 112 are connected by lattice elements, one of which is indicated at 116. In a non-limiting example, lattice element 116 includes a first end 120, a second end 122, and an intermediate portion 123.

In a non-limiting example, lattice element 116 includes a substantially constant diameter and extends between first node 102 and fifth node 110. In a non-limiting example, lattice element 116 has a diameter that is about 2 mm. In another non-limiting example, lattice element 116 has a 1 mm diameter. In a non-limiting example, lattice element 116 is curvilinear. That is, intermediate portion 123 includes a bend portion 125 having an angle of about 132°. It should be understood that the particular diameter of lattice element 116 may vary and can be tuned to specific space requirements between the hood outer panel 22 and the hood inner panel 24. Further, it should be understood that while discussed in connection with lattice element 116, each of the lattice elements of energy absorbing material 90 include similar structure.

Reference will now follow to FIG. 11 in describing energy absorbing material 130 in accordance with another non-limiting example. Energy absorbing material 130 comprises a multi-cellular structure formed from a plurality of interconnected cells 134. In a non-limiting example, a plurality of interconnected cells 134 are connected so as to form a Kevin cell geometry. In a non-limiting example, energy absorbing material 130 has an overall thickness “X” of about 30 mm. In another non-limiting example, energy absorbing material 130 includes an overall thickness of about 25 mm. In yet another non-limiting example, each cell of the plurality of interconnected cells 134 includes a thickness no greater than 20 mm.

Reference will now follow to FIG. 12, with continued reference to FIG. 11 in describing a cell 138 of the plurality of interconnected cells 134. Cell 138 includes a plurality of nodes, two of which are indicated at 142 and 144. Nodes 142 and 144 are joined by a lattice element 148. At this point, it should be understood that each cell 138 includes at least six nodes that are connected through lattice elements similar to that discussed herein in connection with lattice element 148. In a non-limiting example, lattice element 148 includes a first end 154, a second end 156, and an intermediate portion 158.

In a non-limiting example, lattice element 148 includes a substantially constant diameter “d”. In a non-limiting example, lattice element 148 has a diameter that is about 2 mm. In another non-limiting example, lattice element 148 has a 1 mm diameter. It should be understood that the particular diameter of lattice element 148 may vary and can be tuned to specific space requirements between the hood outer panel 22 and the hood inner panel 24. Further, it should be understood that while discussed in connection with lattice element 148, each of the lattice elements of energy absorbing material 130 include similar structure.

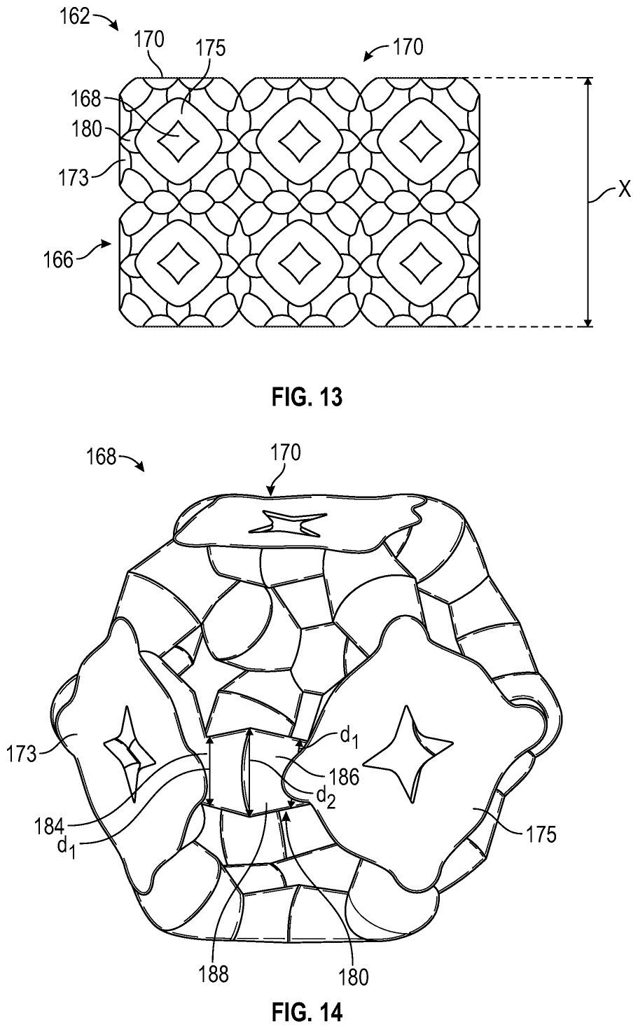

Reference will now follow to FIG. 13 in describing an energy absorbing material 162 in accordance with another non-limiting example. Energy absorbing material 162 comprises a multi-cellular structure formed from a plurality of interconnected cells 166. In a non-limiting example, a plurality of interconnected cells 166 are connected so as to form a Kevin cell geometry. In a non-limiting example, energy absorbing material 162 has an overall thickness of about 30 mm. In another non-limiting example, energy absorbing material 162 includes an overall thickness “X” of about 25 mm. In yet another non-limiting example, each cell of the plurality of interconnected cells 166 includes a thickness no greater than 20 mm.

Reference will now follow to FIG. 14, with continued reference to FIG. 13 in describing a cell 168 of the plurality of interconnected cells 166. Cell 168 includes a plurality of nodes, two of which are indicated at 173 and 175. Nodes 173 and 175 are joined by a lattice element 180. At this point, it should be understood that each cell 168 includes at least six nodes that are connected through lattice elements similar to those discussed herein in connection with lattice element 180. In a non-limiting example, lattice element 180 includes a first end 184, a second end 186, and an intermediate portion 188.

In a non-limiting example, lattice element 180 includes a non-uniform diameter. In a non-limiting example, first end 184 of lattice element 180 has a first diameter “d1”, second end 186 includes a second diameter “d1”, and intermediate portion 188 includes a third diameter “d2” that is distinct from the first diameter and the second diameter. In a non-limiting example, the first diameter and the second diameter is about 2 mm and the third diameter is about 2.5 mm. In another non-limiting example, the first diameter and second diameter is about 1 mm and the third diameter is about 1.5 mm. It should be understood that the particular diameter of lattice element 180 may vary and can be tuned to specific space requirements between the hood outer panel 22 and the hood inner panel 24. Further, it should be understood that while discussed in connection with lattice element 180, each of the lattice elements of energy absorbing material 162 include similar structure.

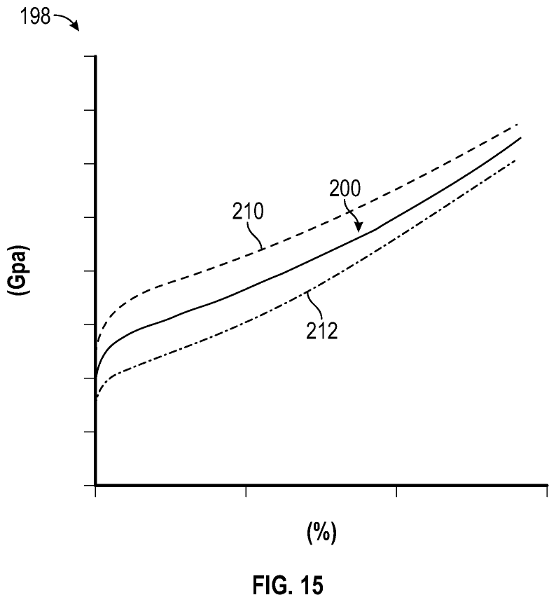

In a non-limiting example, the energy absorbing materials described herein are formed from a 3D printable material, such as nylon, Zytel, or ultramid. That is, the energy absorbing materials described herein are additively manufactured from a nylon material having a response to static loading shown as stress measured in Gigapascals (GPa) versus a percentage of strain FIG. 15. That is, FIG. 15 depicts a graph 198 illustrating material response properties 200 of the printable material used to form energy absorbing materials described herein. The material response properties should remain with an upper boundary 210 and a lower boundary 212 to ensure that the energy absorbing materials conform to head injury criteria (HIC) set by government standards and guidelines.

At this point, it should be appreciated that the non-limiting examples described herein represent energy absorbing material(s) that may be incorporated into a hood assembly of a vehicle to reduce head injuries to a vulnerable road user (VRU). Moreover, the energy absorbing material(s) described herein meet and/or exceed Federal HIC criteria standards while at the same time allowing for adaptability to other vehicle locations and/or vehicle configurations.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A hood assembly of a vehicle, comprising:
a hood outer panel defining an outer surface of the hood assembly;
a hood inner panel defining an inner surface of the hood assembly, and defining a hood cavity between the hood inner panel and the hood outer panel; and
an energy absorbing material disposed at the hood inner panel, the energy absorbing material including a multi-cellular structure formed from a plurality of interconnected cells having a lattice structure, each of the plurality of interconnected cells including at least four nodes and at least one lattice element extending between each of the at least four nodes, the at least one lattice element having a diameter no greater than 2.5 mm.

2. The hood assembly of claim 1, wherein the energy absorbing material is disposed in the hood cavity.

3. The hood assembly of claim 1, wherein the energy absorbing material has one of a trapezoidal or circular cross-sectional shape.

4. The hood assembly of claim 1, wherein the plurality of interconnected cells vary in size in the lattice structure.

5. The hood assembly of claim 1, wherein the plurality of interconnected cells vary in packing density in the lattice structure.

6. The hood assembly of claim 1, wherein the energy absorbing material is secured to one of the hood inner panel or the hood outer panel.

7. The hood assembly of claim 1, wherein the energy absorbing material is secured to one of the hood inner panel or the hood outer panel via adhesive.

8. The hood assembly of claim 1, wherein the energy absorbing material includes a support plate on which the multi-cellular structure is formed.

9. The hood assembly of claim 1, wherein each of the plurality of interconnected cells is formed from one of 3D printable nylon, Zytel, or ultramid.

10. A vehicle comprising:
a body including a hood assembly; and
an energy absorbing material disposed at the hood assembly, the energy absorbing material including a multi-cellular structure formed from a plurality of interconnected cells having a lattice structure, each of the plurality of interconnected cells including at least four nodes and at least one lattice element extending between each of the at least four nodes, the at least one lattice element having a diameter no greater than 2.5 mm.

11. The vehicle of claim 10, wherein the hood assembly includes:
a hood outer panel defining an outer surface of the hood assembly; and
a hood inner panel defining an inner surface of the hood assembly, and defining a hood cavity between the hood inner panel and the hood outer panel;
wherein the energy absorbing material is disposed at the hood inner panel.

12. The vehicle of claim 11, wherein the energy absorbing material is disposed in the hood cavity.

13. The vehicle of claim 10, wherein the energy absorbing material has one of a trapezoidal or circular cross-sectional shape.

14. The vehicle of claim 10, wherein the plurality of interconnected cells vary in size in the lattice structure.

15. The vehicle of claim 10, wherein the energy absorbing material is disposed over one of a headlamp or a suspension tower of the vehicle.

16. The vehicle of claim 10, wherein the plurality of interconnected cells vary in packing density in the lattice structure.

17. The vehicle of claim 11, wherein the energy absorbing material is secured to one of the hood inner panel or the hood outer panel.

18. The vehicle of claim 11, wherein the energy absorbing material is secured to one of the hood inner panel or the hood outer panel via adhesive.

19. An energy absorbing material, comprising:
a multi-cellular structure formed from a plurality of interconnected cells having a lattice structure, each of the plurality of interconnected cells including at least four nodes and at least one lattice element extending between each of the at least four nodes, the at least one lattice element having a diameter no greater than 2.5 mm; wherein the plurality of interconnected cells vary in one or more of size or packing density in the lattice structure.
